(19) United States
(12) Patent Application Publication
(10) Pub. No.: US 2010/0067799 A1
(43) Pub. Date: Mar. 18, 2010

(54) GLOBALLY INVARIANT RADON FEATURE TRANSFORMS FOR TEXTURE CLASSIFICATION

(75) Inventors: Guangcan Liu, Beijing (CN); Zhouchen Lin, Beijing (CN); Xiaoou Tang, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/212,222

(22) Filed: Sep. 17, 2008

(51) Int. Cl. G06K 9/46

(52) U.S. Cl. 382/190

(57) ABSTRACT

A “globally invariant Radon feature transform,” or “GIRFT,” generates feature descriptors that are both globally affine invariant and illumination invariant. These feature descriptors effectively handle intra-class variations resulting from geometric transformations and illumination changes to provide robust texture classification. In general, GIRFT considers images globally to extract global features that are less sensitive to large variations of material in local regions. Geometric affine transformation invariance and illumination invariance is achieved by converting original pixel represented images into Radon-pixel images by using a Radon Transform. Canonical projection of the Radon-pixel image into a quotient space is then performed using Radon-pixel pairs to produce affine invariant feature descriptors. Illumination invariance of the resulting feature descriptors is then achieved by defining an illumination invariant distance metric on the feature space of each feature descriptor.

### BACKGROUND

1. Technical Field

A “globally invariant Radon feature transform,” or “GIRFT,” provides various techniques for generating feature descriptors that are suitable for use in various texture classification applications, and in particular, various techniques for using Radon Transforms to generate feature descriptors that are both globally affine invariant and illumination invariant.

2. Related Art

Texture classification and analysis is important for the interpretation and understanding of real-world visual patterns. It has been applied to many practical vision systems such as biomedical imaging, ground classification, segmentation of satellite imagery, and pattern recognition. The automated analysis of image textures has been the topic of extensive research in the past decades. Existing features and techniques for modeling textures include techniques such as gray level co-occurrence matrices, Gabor transforms, bidirectional texture functions, local binary patterns, random fields, autoregressive models, wavelet-based features, textons, affine adaption, fractal dimension, local scale-invariant features, invariant feature descriptors, etc.

However, while many conventional texture classification and analysis techniques provide acceptable performance on real world datasets in various scenarios, a number of texture classification problems remain unsolved. For example, as is known to those skilled in the art of texture classification and analysis, illumination variations can have dramatic impact on the appearance of a material. Unfortunately, conventional texture classification and analysis techniques generally have difficulty in handling badly illuminated images.

Another common problem faced by conventional texture classification and analysis techniques is a difficulty in simultaneously eliminating inter-class confusion and intra-class variation problems. In particular, conventional techniques attempts to reduce the inter-class confusion may produce more false-positives, which is detrimental to efforts to reduce intra-class variation, and vice versa. As such, conventional texture classification and analysis techniques generally fail to provide texture features that are not only discriminative across many classes but also invariant to key transformations, such as geometric affine transformations and illumination changes.

Finally, many recently developed texture analysis applications require more robust and effective texture features. For example, the construction of an appearance model in object recognition applications generally requires the clustering of local image patches to construct a “vocabulary” of object parts, which essentially is an unsupervised texture clustering problem that needs the texture descriptors to be simple (few parameters to tune) and robust (perform well and stably).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, a “globally invariant Radon feature transform,” or “GIRFT,” as described herein, provides various techniques for generating feature descriptors that are both globally affine invariant and illumination invariant. These feature descriptors effectively handle intra-class variations resulting from geometric transformations and illumination changes to provide robust texture classification.

In contrast to conventional feature classification techniques, these GIRFT-based techniques consider images globally to extract global features that are less sensitive to large variations of material in local regions. Geometric affine transformation invariance and illumination invariance is achieved by converting original pixel represented images into Radon-pixel images by using a Radon Transform. Canonical projection of the Radon-pixel image into a quotient space is then performed using Radon-pixel pairs to produce affine invariant feature descriptors. Illumination invariance of the resulting feature descriptors is then achieved by defining an illumination invariant distance metric on the feature space of each feature descriptor.

More specifically, in contrast to conventional texture classification schemes that focus on local features, the GIRFT-based classification techniques described herein consider the entire image globally. Further, while some conventional texture classification schemes model textures using globally computed fractal dimensions, the GIRFT-based classification techniques described herein instead extract global features to characterize textures. These global features are less sensitive to large variations of material in local regions than local features.

For example, modeling local illumination conditions is difficult using locally computed features since the illuminated texture is not only dependent on the lighting conditions but is also related to the material surface, which varies significantly from local views. However, the global modeling approach enabled by the GIRFT-based techniques described herein is fully capable of modeling local illumination conditions. Further, in contrast to typical feature classification methods which often discard the color information and convert color images into grayscale images, the GIRFT-based techniques described herein make use of the color information in images to produce more accurate texture descriptors. As a result, the GIRFT-based techniques described herein achieve higher classification rates than conventional local descriptor based methods.

Considering the feature descriptor generation techniques described above, the GIRFT-based techniques provide several advantages over conventional classification approaches. For example, since the GIRFT-based classification techniques consider images globally, the resulting feature vectors are insensitive to local distortions of the image. Further, the GIRFT-based classification techniques described herein are capable of adequately handling unfavorable changes in illumination conditions, e.g., underexposure. Finally, in various embodiments, the GIRFT-based classification techniques described herein include two parameters, neither of which requires careful adjustment.

In view of the above summary, it is clear that the GIRFT described herein provides various unique techniques for generating globally invariant feature descriptors for use in texture classification applications. In addition to the just described benefits, other advantages of the GIRFT will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 illustrates a general flow diagram for computing feature descriptors and distance metrics using a “globally invariant Radon feature transform,” or “GIRFT,” as described herein.

FIG. 2 provides an exemplary architectural flow diagram that illustrates program modules for implementing various embodiments of the GIRFT, as described herein.

FIG. 3 provides a graphical example of a prior art Radon Transform, as described herein

FIG. 4 provides a graphical representation of a “Type I” Radon-pixel pair, as described herein.

FIG. 5 provides a graphical representation of a “Type II” Radon-pixel pair, as described herein.

FIG. 6 provides an example of an input image texture, as described herein.

FIG. 7 provides an example of a collection of Radon-pixels belonging to an “equivalence class” recovered from a “GIRFT key” generated from the input texture of FIG. 6, as described herein.

FIG. 8 illustrates a general system flow diagram that illustrates exemplary methods for implementing various embodiments of the GIRFT, as described herein.

FIG. 9 is a general system diagram depicting a simplified general-purpose computing device having simplified computing and I/O capabilities for use in implementing various embodiments of the GIRFT, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Introduction:

In general, a “globally invariant Radon feature transform,” or “GIRFT,” as described herein, provides various techniques for generating feature descriptors that are both globally affine invariant and illumination invariant. These feature descriptors effectively handle intra-class variations resulting from geometric transformations and illumination changes to provide robust texture classification.

In contrast to conventional feature classification techniques, the GIRFT-based techniques described herein consider images globally to extract global features that are less sensitive to large variations of material in local regions. Geometric affine transformation invariance and illumination invariance is achieved by converting original pixel represented images into Radon-pixel images by using a Radon Transform. Canonical projection of the Radon-pixel image into a quotient space is then performed using Radon-pixel pairs to produce affine invariant feature descriptors. Illumination invariance of the resulting feature descriptors is then achieved by defining an illumination invariant distance metric on the feature space of each feature descriptor.

More specifically, the GIRFT-based classification techniques described herein achieve both geometric affine transformation and illumination change invariants using the following three-step process:

First, the GIRFT-based classification techniques convert original pixel represented images into Radon-pixel images by using the Radon Transform. The resulting Radon representation of the image is more informative in geometry and has much lower dimension than the original pixel-based image.

Next, the GIRFT-based classification techniques project an image from the space, X, of Radon-pixel pairs onto its quotient space, X/˜, by using a canonical projection, where “˜” is an equivalence relationship among the Radon-pixel pairs under the affine group. The canonical projection is invariant up to any action of the affine group. Consequently, X/˜ naturally forms an invariant feature space. Therefore, for a given image, GIRFT produces a vector that is affine invariant. The resulting GRIFT-based feature vector (also referred to herein as a “feature descriptor”) is an l-variate statistical distribution for each dimension of the vector.

Finally, the GIRFT-based classification techniques define an illumination invariant distance metric on the feature space such that illumination invariance of the resulting feature vector is also achieved. With these pairwise distances given, the GIRFT-based classification techniques compute a kernel matrix, and use kernel consistent learning algorithms to perform texture classification.

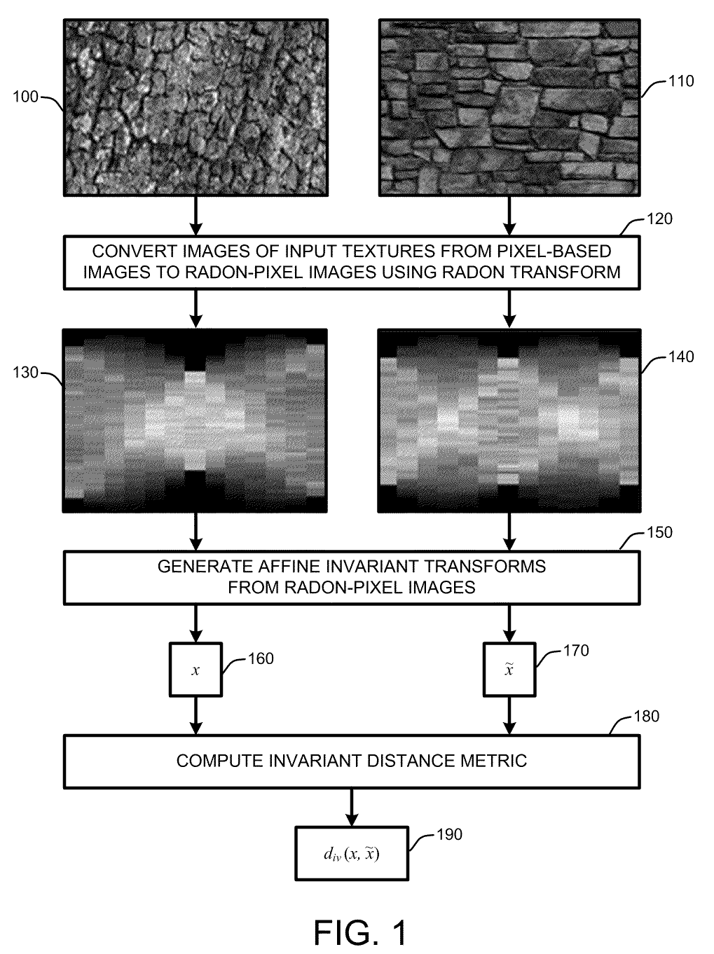

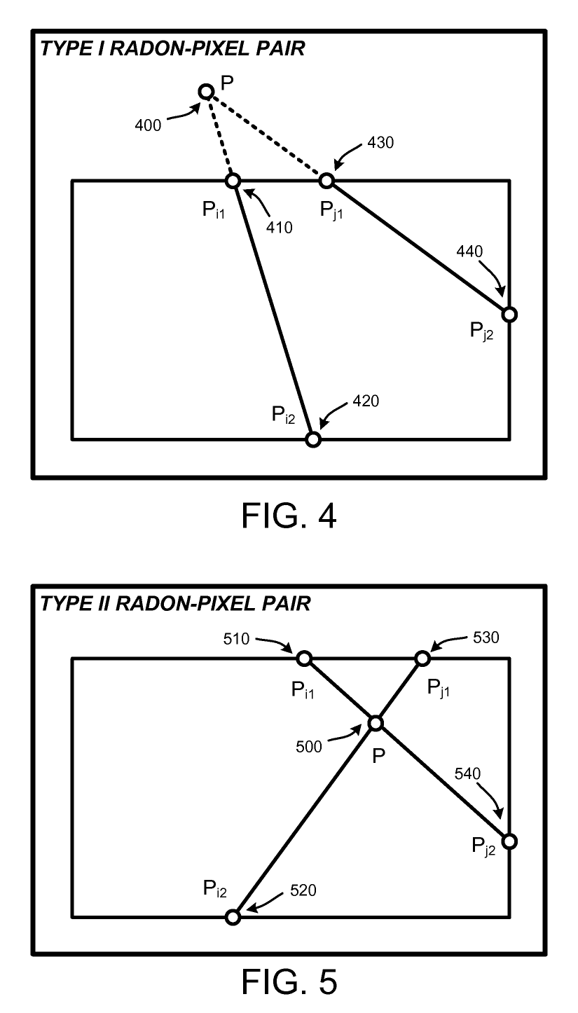

For example, as illustrated by FIG. 1, given two texture images, 100 and 110, the GIRFT first converts 120 each image into Radon-pixel images 130 and 140, using the Radon Transform. Since one Radon-pixel in either of the Radon-pixel images, 130 and 140, corresponds to a line segment in the corresponding original image (100 or 110), and a pair of Radon-pixels in one of the Radon-pixel images, corresponds to four triangles (as discussed in further detail below with respect to FIG. 4 and FIG. 5), there are two affine invariants associated with each pair of Radon-pixels. Consequently, the GIRFT uses this property to generate 150 a fast affine invariant transform on each Radon-pixel image. Each of these transforms is then transformed into a vector, x and \tilde{x} (160 and 170, respectively), of an m-dimensional vector space.

Note that the attributes of each vector are modeled using a multivariate statistical distribution, e.g., Gaussians, mixtures of Gaussians, etc. For example, as discussed in further detail below, using a Gaussian distribution for modeling the multivariate statistical distribution, vector x would be modeled as: x=(N₁(μ₁, Σ₁), . . . , Nₘ(μₘ,Σₘ))^{T}. Finally, the GIRFT computes 180 an affine invariant distance metric 190, d(x,\tilde{x}), between the vectors, x and x (160 and 170, respectively), on the corresponding vector space, X. In various embodiments, this distance metric 190 is used to measure similarity between texture images 100 and 110.

1.1 System Overview:

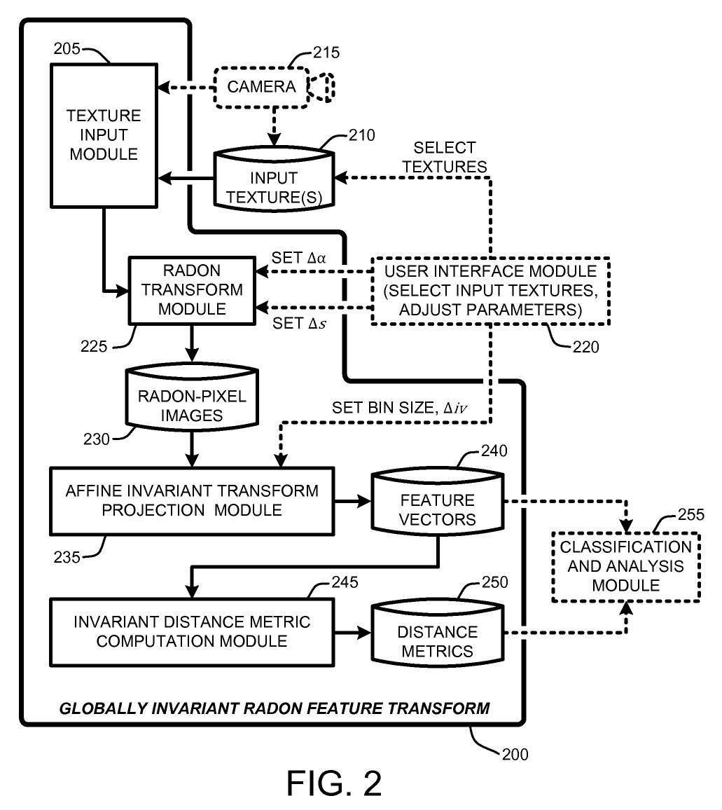

As noted above, the “globally invariant Radon feature transform,” or “GIRFT” provides various techniques for processing input textures using Radon Transforms to generate globally invariant feature descriptors and distance metrics for use in texture classification and analysis applications. The processes summarized above are illustrated by the general system diagram of FIG. 2. In particular, the system diagram of FIG. 2 illustrates the interrelationships between program modules for implementing various embodiments of the GIRFT, as described herein. Furthermore, while the system diagram of FIG. 2 illustrates a high-level view of various embodiments of the GIRFT, FIG. 2 is not intended to provide an exhaustive or complete illustration of every possible embodiment of the GIRFT as described throughout this document.

In addition, it should be noted that any boxes and interconnections between boxes that may be represented by broken or dashed lines in FIG. 2 represent alternate embodiments of the GIRFT described herein, and that any or all of these alternate embodiments, as described below, may be used in combination with other alternate embodiments that are described throughout this document.

In general, as illustrated by FIG. 2, the processes enabled by the GIRFT 200 begin operation by using a texture input module 205 to receive a pair of input textures (i.e., pixel-based images) from a set or database 210 of texture samples or images. Such input textures 210 can be either pre-recorded or pre-computed using conventional techniques, or can be captured from some signal input source (such as a digital still or video camera 215) in the case where actual images are used as input textures. In various embodiments, an optional user interface module 220 is used to select the input textures 210 that are to be passed to the texture input module 205.

Regardless of the source of the input textures 210, the texture input module 205 passes the received input textures to a Radon Transform module 225. The Radon Transform module 225 converts each of the original pixel-based input textures into Radon-pixel images 230 by using the Radon Transform, as discussed in further detail in Section 2.2. In various embodiments, the user interface module 220 allows user adjustment of a “Δα” parameter that controls the number of projection directions used in constructing the Radon-pixel images 230 from each of the input textures 210, as discussed in further detail in Section 2.2. Note that it is not necessary for the user to adjust the Δα parameter, and that this parameter can be set at a fixed value, if desired, as discussed in Section 2.2.

In addition, in various embodiments, the user interface module 220 also allows optional adjustment of a second parameter, Δs, for use by the Radon Transform module 225. In general, as discussed in further detail in Section 2.2, “s” is a signed distance (in pixels) for use in computing the Radon Transform. However, while the value of s can be user adjustable, if desired, setting this value to 1 pixel was observed to provide good results in various tested embodiments, while increasing the value of s generally increases computational overhead without significantly improving performance or accuracy of the feature descriptors generated by the GIRFT-based techniques described herein.

Once the Radon-pixel images 230 have been generated from the input textures 210 by the Radon Transform module 225, an affine invariant transform projection module 235 performs a canonical projection of the Radon-pixel images 230 into a quotient space using Radon-pixel pairs from each Radon-pixel image to produce affine invariant feature vectors 240 (also referred to herein as “feature descriptors”) for each Radon-pixel image. This process, described in detail in Section 2.3 uses a “bin-size parameter,” Δiv, that generally controls the dimensionality of the resulting feature vectors 240. In general, a larger bin size, Δiv, corresponds to a smaller feature vector (i.e., lower dimensionality). As discussed in Section 2.3, in various embodiments, the bin size parameter, Δiv, is generally set within a range of 0<Δiv≦0.5. This bin size value can be optimized through experimentation, if desired.

Once the feature vectors 240 have been generated for each of the input textures 210, an invariant distance metric computation module 245 is used to generate an invariant distance metric, d(x,\tilde{x}), for the pair of feature vectors 240. This process is discussed in further detail in Section 2.4.

Finally, given the feature vectors 240 and distance metrics 250, kernel-based classification and analysis techniques can be used to provide classification and analysis of the input textures 205. An optional classification and analysis module 255 is provided for this purpose. See Section 2.5 for an example of a kernel-based classification and analysis process that makes use of the feature vectors 240 and distance metrics 250 for evaluating the input textures 210.

2.0 Operational Details of the GIRFT:

The above-described program modules are employed for implementing various embodiments of the GIRFT. As summarized above, the GIRFT provides various techniques for processing input textures using the Radon Transform to generate globally invariant feature descriptors and distance metrics for use in texture classification and analysis applications. The following sections provide a detailed discussion of the operation of various embodiments of the GIRFT, and of exemplary methods for implementing the program modules described in Section 1 with respect to FIG. 1 and FIG. 2. In particular, the following sections examples and operational details of various embodiments of the GIRFT, including: an operational overview of the GIRFT; the Radon Transform; generating affine invariant feature transforms from Radon-pixel images; computing illumination invariant distance metrics; and classification examples and considerations using GIRFT-based feature descriptors.

2.1 Operational Overview:

As noted above, the GIRFT-based processes described herein, provides various techniques for generating feature descriptors that are both globally affine invariant and/or illumination invariant by considering images globally, rather than locally. These feature descriptors effectively handle intra-class variations resulting from geometric transformations and illumination changes to enable robust texture classification applications. Geometric affine transformation invariance and illumination invariance is achieved by converting original pixel represented images into Radon-pixel images by using the Radon Transform. Canonical projection of the Radon-pixel image into a quotient space is then performed using Radon-pixel pairs to produce affine invariant feature descriptors. Illumination invariance of the resulting feature descriptors is then achieved by defining an illumination invariant distance metric on the feature space of each feature descriptor.

The above summarized capabilities provide a number of advantages when used in feature classification and analysis applications. For example, since the GIRFT-based classification techniques consider images globally, the resulting feature vectors are insensitive to local distortions of the image. Further, the GIRFT-based classification techniques described herein are fully capable of dealing with unfavorable changes in illumination conditions, e.g., underexposure. Finally, in various embodiments, the GIRFT-based classification techniques described herein includes two parameters, neither of which requires careful adjustment. As such, little or no user interaction is required in order for the GIRFT-based classification techniques described herein to provide good results.

2.2 Radon Transform:

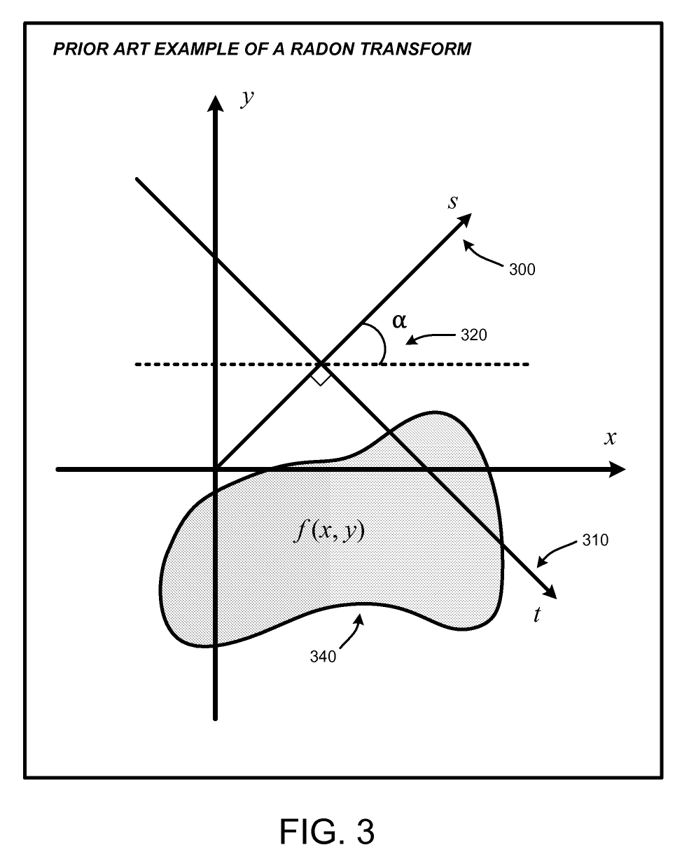

In general, as is known to those skilled in the art, the two-dimensional Radon Transform is an integral transform that computes the integral of a function along straight lines. For example, as illustrated by FIG. 3, every straight line (300, 310) can be represented as (x(t), y(t))=t(sin α, −cos α)+s(cos α, sin α), where s is the signed distance from the origin to the line, and α (320) is the angle between the normal of the line and the x axis. Note that while the value of s can be user adjustable, if desired, setting this value to 1 pixel was observed to provide good results in various tested embodiments. Given this definition of a line, the Radon Transform of a function ƒ(x,y) (340) on the plane is defined by Equation (1), where:

$$R ( f ) ( α , s ) = {\int }_{- ∞}^{+ ∞} f ( x ( t ) , y ( t ) ) d t \qquad Equation ( 1 )$$

The Radon Transform is a special case of image projection operations. It has found wide applications in many areas such as tomographic reconstruction. The Radon Transform has also been applied to many computer vision areas, such as image segmentation, structural extraction by projections, determining the orientation of an object, recognition of Arabic characters, and one dimensional processing, filtering, and restoration of images. When used to transform images, the Radon Transform converts a pixel-based image into an equivalent, lower-dimensional, and more geometrically informative “Radon-pixel image” by projecting the pixel-based image in 180°/Δα directions. For example, assuming α=30°, the pixel-based image will be projected in 6 directions (i.e., 180/30).

Further, the Radon-pixel image has more geometric information than the original pixel image does. In particular, it can be seen that one Radon-pixel corresponds to a line segment which needs two pixels in the original image to describe. Furthermore, a single Radon-pixel contains the information of a line segment in the original image. This property makes Radon-pixels more robust to image noise. In addition, the dimension of the Radon-pixel representation of an image is much lower than that of the original image. In particular, for an n-pixel image, the number of Radon-pixels is on the order of about \sqrt{n}.

Finally, another advantage provided by the use of the Radon Transform is that the Radon Transform is invertible. In other words, the invertibility of the Radon Transform allows the original image to be recovered from its Radon-pixel image. This invertibility is one of the chief characteristics that distinguish the Radon Transform from other transformations such as the well known scale-invariant feature transform (SIFT).

2.3 Generating Affine Invariant Feature Transforms:

To achieve the affine invariant property of the feature descriptors generated by the GIRFT-based techniques described herein, it is necessary to find a projection from the image space onto a vector space such that the projection is invariant up to any action of the affine group (i.e., any geometric transformation, such as scaling, rotation, shifts, warping, etc.). In particular, given the image space X that contains the observations being investigates, consider a canonical projection Π from X to its quotient space, X/˜, given by Π(x)=[x], where ˜ is an equivalence relation on X, and [x] is the equivalence class of the element x in X. For an affine transformation group, G, the equivalence relation ˜ is defined by Equation (2), where:

x˜y, if and only if ∃g εG, such that y=g(x) Equation (2)

In other words, for a particular affine transformation group, G, x is equivalent to y, if there is some element g in the affine transformation group such that y=g(x). Given this definition, the canonical projection Π is invariant up to G because of the relation: Π(g(x))=[g(x)]=[x]=Π(x),∀gεG.

From the above analysis, it can be seen that the quotient space is a natural invariant feature space. Therefore, to obtain an affine invariant feature transform, it is only necessary to determine the quotient space X/˜, where ˜ is defined according to the resulting affine transformation group. In general, there are three steps to this process, as described in further detail below:

1. Selecting the observation space X of an image;

2. Determining the bases of quotient space X/˜; and

3. Describing the equivalence classes.

2.3.1 Selecting the Observation Space of an Image:

This first step plays the role of feature selection. It is important since if the observation space, X, is inappropriate, the resulting feature descriptors will be ineffective for use in classification and analysis applications. For example, if an image is viewed as a set of single pixels, then the quotient space is 1-dimensional, and only a single scalar is used to describe an image. Under conventional affine grouping techniques, to ensure the discriminability of features, it is necessary to consider at least pixel quadruples (four-pixel groups), which requires a very large computational overhead. However, in contrast to conventional techniques, the GIRFT-based techniques described herein only need to consider Radon-pixel pairs (two-pixel groups) in the Radon-pixel representation of the image, as every Radon-pixel, r, corresponds to all the pixels on the corresponding line segment in the original image. As a result, the computational overhead of the GIRFT-based techniques described herein is significantly reduced.

In particular, let an image I be represented by a Radon-pixel image {r₁, . . . , rₖ}. The observation space is then a set of Radon-pixel pairs X={rᵢ, rⱼ}. Further, since for an n-pixel image, the number of Radon-pixels is O(\sqrt{n}), the dimension of X is therefore O(n).

2.3.2 Determining the Bases of the Quotient Space:

The quotient space, X/˜, acts as the invariant feature space in the GIRFT. It consists of a set of equivalence classes: X/˜={[rᵢ, rⱼ]}. In view of Equation (2), [rᵢ,rⱼ]=[r_{i′},r_{j′}] if and only if ∃gεG such that (rᵢ, rⱼ)=g((r_{i′},r_{j′})). Therefore, it would appear to be necessary to determine all unique equivalence classes. This determination can be achieved by finding all the invariants under the affine transformations. In general, it is computationally difficult to find all such invariants. However, in practice, it is unnecessary to find all invariants. In fact, it is only necessary to find a sufficient number of invariants to determine a subspace of X/˜.

In particular, as illustrated by FIG. 4 and FIG. 5, there are two types of Radon-pixel pairs. For “Type I” pairs, as illustrated by FIG. 4, the corresponding line segments in the original pixel image have intersection points (400) outside the group of Radon-pixels (410, 420, 430 and 440). For “Type II” pairs, the intersection points (500) are inside the group of Radon-pixels (510, 520, 530 and 540). As the area is a relative invariant under the affine transformation group, G, as discussed above, the quotient of the areas of any two triangles is invariant. Therefore, a pair of Radon-pixels results in two invariants, i.e., iv₁ and iv₂.

More specifically, for a Radon-pixel pair (rᵢ, rⱼ) whose ends in the original pixel image are Pᵢ₁, Pᵢ₂, Pⱼ₁ and Pⱼ₂ (FIG. 3), respectively, there are two invariants under the affine transformation group, G:

$${iv}_{1} = \frac{\vert {PP}_{i 1} {P}_{j 1} \vert}{\vert {PP}_{i 2} {P}_{j 2} \vert} and {iv}_{2} = \frac{\vert {PP}_{i 1} {P}_{j 2} \vert}{\vert {PP}_{i 2} {P}_{j 1} \vert} \qquad Equation ( 3 )$$

where |•| denotes the area of a triangle. As the order of these two triangles is unimportant, it is assumed that 0<iv₁≦iv₂≦1. Moreover, as shown by FIG. 4 and FIG. 5, the intersection type (e.g., “Type I” or “Type II”) is also preserved by affine transformations. This can be embodied by the above two invariants by using an oriented area instead, i.e., −1≦iv₁≦iv₂≦1. These two scalars form the coordinate of the bases of X/˜. By breaking the interval [−1, 1] into bins, as illustrated by Equation 4:

[−1,−1+Δiv], [−1+Δiv, −1+2Δiv], . . . , [1−Δiv, 1] Equation (4)

where Δiv is the bin size, a finite dimensional representation of the quotient space is achieved. The coordinates are only dependent on the bin size Δiv.

Note that in tested embodiments, the bin size, Δiv, was set to a value on the order of about 0.1, and was generally set within a range of 0<Δiv≦0.5. The bin size, Δiv, can be optimized through experimentation, if desired. In general, a larger bin size corresponds to a smaller feature vector. Thus, the bin size can also be set as a function of a desired size for the resulting feature vectors.

For example, if the bin size is set such that Δiv=0.1, any sizes of images will correspond to feature vector on the order of about 132-dimensions in the resulting fixed-dimensional space. In particular, some bins are always zero, and after removing these zero bins there are 132 bins (or less) remaining in the case of a bin size of Δiv=0.1, depending upon the input texture image.

Note that the dimension of the feature vector is fixed for particular images because the invariants are constant when image sizes change, which is just a particular case of affine transformation (i.e., image scaling). This property also implies that the computation of determining X/˜, which is the most computation costly part of the GIRFT-based feature descriptor generation process, only needs to be executed once. Therefore GIRFT can be computationally efficient if appropriately implemented.

2.3.3 Describing the Equivalence Classes:

By determining the bases of the quotient space, a texture is then represented by an m-dimensional GIRFT feature vector, as illustrated by Equation 5, where:

x=([(rᵢ₁,rⱼ₁)]₁, . . . , [(rᵢₘ,rⱼₘ)]ₘ)^{T} Equation (5)

each dimension of which is an equivalence class [(rᵢₖ,rⱼₖ)]ₖ, referred to herein as a “GIRFT key.”

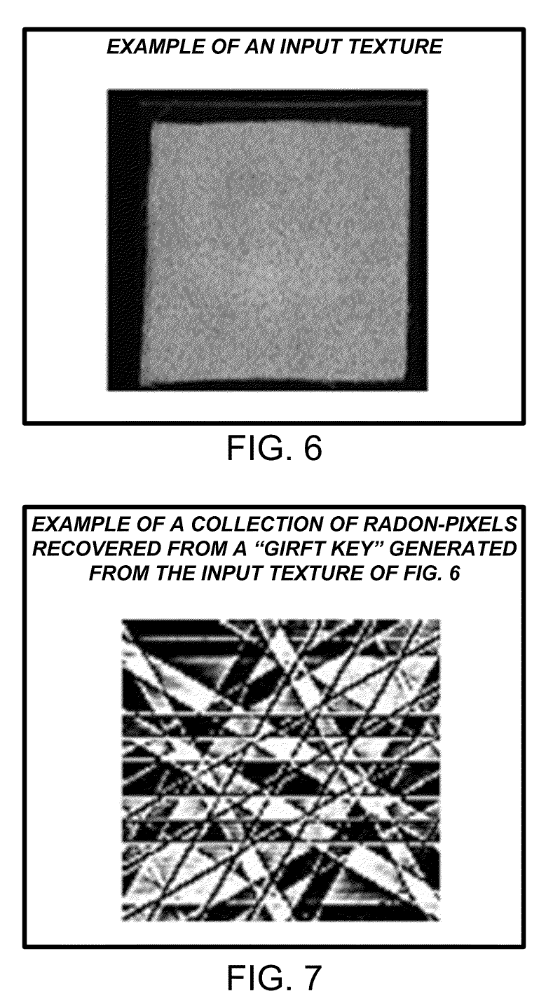

The GIRFT-based techniques described herein are operable with images of any number of channels (e.g., RGB images, YUV images, CMYK images, grayscale images, etc.). For example, for three channel images (such as RGB-color images), corresponding Radon-pixels contain three scalars. Therefore, in the case of a three-channel image, the GIRFT key is a set of 6-dimensional vectors in R⁶. Further, each Radon-pixel pair (rᵢₖ,rⱼₖ) is independent of the permutation if rᵢₖ and rⱼₖ (i.e., (rᵢₖ,rⱼₖ)=(rⱼₖ,rᵢₖ)). Therefore, assuming an RGB image, for each Radon-pixel pair of a RGB color image, a 6-dimensional vector, (k₁, . . . , k₆), is computed as as follows:

$${k}_{1} = \frac{1}{2} \vert R ( {r}_{ik} ) - R ( {r}_{jk} ) \vert , {k}_{2} = \frac{1}{2} \vert G ( {r}_{ik} ) - G ( {r}_{jk} ) \vert , \\ {k}_{3} = \frac{1}{2} \vert B ( {r}_{ik} ) - B ( {r}_{jk} ) \vert , {k}_{4} = \frac{1}{2} \vert R ( {r}_{ik} ) + R ( {r}_{jk} ) \vert , \\ {k}_{5} = \frac{1}{2} \vert G ( {r}_{ik} ) + G ( {r}_{jk} ) \vert , {k}_{6} = \frac{1}{2} \vert B ( {r}_{ik} ) + B ( {r}_{jk} ) \vert \qquad Equation ( 6 )$$

where R(•), G(•) and B(•) are the red, the green, and the blue intensity values of the Radon-pixel, respectively. Note that while other quantities may be defined, if desired, the six quantities defined in Equation (6) are used because they are the simplest invariants under the permutation of rᵢₖ and rⱼₖ. Note that FIG. 6 provides a graphical example of an original input texture, while FIG. 7 provides an example of an image recovered from one GIRFT key (generated from the input texture of FIG. 6) which is a collection of Radon-pixels that belong to an equivalence class. Note that in the example provided by FIG. 7, Δα=30° and Δiv=0.1.

In general, a multivariate statistical distribution is used to fit the distribution of the vector (k₁, . . . , k₆) for every GIRFT key. In a tested embodiment, a Gaussian distribution was used. However, other distributions can also be used, if desired. Assuming a Gaussian distribution, the GIRFT feature vector of a texture image is represented by an m-dimensional Gaussian distribution vector, i.e.,

x=(N₁(μ₁,Σ₁), . . . , Nₘ(μₘ,Σₘ))^{T} Equation (7)

where μᵢ and Σᵢ are the mean and the covariance matrix of a 6-variate Gaussian distribution (again, assuming a three channel image), respectively.

2.4 Computing Illumination Invariant Distance Metrics:

Modeling illumination changes is generally difficult because it is a function of both lighting conditions and the material reflection properties of the input texture. However, from a global view of a texture, it is acceptable to consider a linear model, I→sI+t, with two parameters s (scale) and t (translation). Conventional techniques often attempt to address this problem using various normalization techniques. Clearly, the impact of the scale, s, can be eliminated by normalizing the intensities of an image to sum to one. However, such normalization will change the image information, which can result in the loss of many useful image features. In contrast to these conventional techniques, the GIRFT-based techniques described herein achieve illumination invariance in various embodiments by computing a special distance metric.

For simplicity, the GIRFT-based techniques described herein starts with a distance metric without considering any in illumination. For example, given two GIRFT vectors, x and \tilde{x}, computed as described with respect to Equation (7), the distance between those vectors is computed as illustrated by Equation (8), where:

$$d ( x , \tilde{x} ) = {\sum }_{i = 1}^{m} J ( {N}_{i} , {\tilde{N}}_{i} ) \qquad Equation ( 8 )$$

where J(•,•) is the “Jeffrey divergence,” i.e., the symmetric version of the KL divergence: J(Nᵢ,Ñᵢ)=KL(Nᵢ|Ñᵢ)+KL(Ñᵢ|Nᵢ). Therefore, given the model in Equation (7), the distance can be computed as illustrated by Equation (9), where:

$$d ( x , \tilde{x} ) = \frac{1}{2} {\sum }_{i = 1}^{m} {( {u}_{i} - {\tilde{u}}_{i} )}^{T} ( {Σ}_{i}^{- 1} + {\tilde{Σ}}_{i}^{- 1} ) ( {u}_{i} - {\tilde{u}}_{i} ) + \frac{1}{2} {\sum }_{i = 1}^{m} Tr ( {Σ}_{i} {\tilde{Σ}}_{i}^{- 1} + {\tilde{Σ}}_{i} {Σ}_{i}^{- 1} ) - m l \qquad Equation ( 9 )$$

where l=6 is the number of variables in the Gaussian distribution (which depends upon the number of channels in the image, as discussed in Section 2.3.3). This distance is a standard metric as it satisfies positive definiteness, symmetry, and the triangle inequality.

Consider that an image I is recaptured with different illumination, and thus becomes I_{{s,t}}=sI+t. In this case, the Gaussian distribution, Nᵢ(μᵢ, Σᵢ), becomes Nᵢ(μᵢ+te,s²Σᵢ), where e is an l-dimensional vector with all ones. Therefore, for two observed images I_{{s,t}}, and Ĩ_{{\tilde{s},\tilde{t}}}, their distance should be d_{{s,t,\tilde{s},\tilde{t}}}(x,\tilde{x}). Replacing μᵢ, ũᵢ, Σᵢ and \tilde{Σ}ᵢ by sμᵢ+t, \tilde{s}ũᵢ+\tilde{t}, s²Σᵢ and \tilde{s}²\tilde{Σ}ᵢ in Equation (9), respectively, it can be seen that d_{{s,t,\tilde{s},\tilde{t}} only depends on two variables: D}ₛ=s/\tilde{s} and Δt=t−\tilde{t}, i.e.,

d_{{s,t,\tilde{s},\tilde{t}}}(x,\tilde{x})=d_{{D}_{ₛ}_{,Δt}}(x,\tilde{x}) Equation (10)

Although the illumination conditions are unknown and it is difficult or impossible to estimate the parameters for each image, illumination invariance can be achieved by minimizing d_{{D}_{ₛ}_{,Δt}}. In particular, an illumination invariant distance, dᵢᵥ, is computed as illustrated by Equation (10), where:

$${d}_{iv} ( x , \tilde{x} ) = {min}_{{D}_{S} , Δ t} {d}_{\{ {D}_{S} , Δ t \}} ( x , \tilde{x} ) \qquad Equation ( 11 )$$

which means that the distance between two textures I and Ĩ is computed after matching their illuminations at the best. Equation (11) can be minimized by simply minimizing a one-variable function of Dₛ, as illustrated by Equation (12), where:

$${d}_{iv} ( x , \tilde{x} ) = {min}_{{D}_{S}} f ( {D}_{S} ) \qquad Equation ( 12 )$$

where

$$f ( {D}_{S} ) = \frac{{( {D}_{S} )}^{2}}{2} {\sum }_{i = 1}^{m} Tr ( {Σ}_{i} {\tilde{Σ}}_{i}^{- 1} + {μ}_{i}^{T} {\tilde{Σ}}_{i}^{- 1} {\tilde{μ}}_{i} ) + \frac{1}{2 {( {D}_{S} )}^{2}} {\sum }_{i = 1}^{m} Tr ( {\tilde{Σ}}_{i} {Σ}_{i}^{- 1} + {\tilde{μ}}_{i}^{T} {Σ}_{i}^{- 1} {μ}_{i} ) - {D}_{S} {\sum }_{i = 1}^{m} {μ}_{i}^{T} {\tilde{Σ}}_{i}^{- 1} {\tilde{μ}}_{i} - \frac{1}{{D}_{S}} {\sum }_{i = 1}^{m} {\tilde{μ}}_{i}^{T} {Σ}_{i}^{- 1} {μ}_{i} - \frac{1}{2} {\sum }_{i = 1}^{m} \frac{{( {e}^{t} ( \frac{1}{{D}_{S}} {Σ}_{i}^{- 1} + {D}_{S} {\tilde{Σ}}_{i}^{- 1} ) ( {D}_{S} {μ}_{i} - {\tilde{μ}}_{i} ) )}^{2}}{{e}^{t} ( {Σ}_{i}^{- 1} + {( {D}_{S} )}^{2} {\tilde{Σ}}_{i}^{- 1} ) e} + \frac{1}{2} {\sum }_{i = 1}^{m} ( {μ}_{i}^{T} {Σ}_{i}^{- 1} {μ}_{i} + {\tilde{μ}}_{i}^{T} {\tilde{Σ}}_{i}^{- 1} {\tilde{μ}}_{i} ) - m l \qquad Equation ( 13 )$$

and where Δt can be easily found as a function of Dₛ by letting

$$\frac{\partial {d}_{\{ {D}_{S} , Δ t \}}}{\partial Δ t} = 0.$$

Note that substituting the expression of Δt in Dₛ with d_{{D}_{ₛ}_{,Δt}}(x,\tilde{x}) yields f(Dₛ).

In general, this invariant distance is effective in handling large illumination changes. Note that the distance computed by Equation (11) satisfies positive definiteness and symmetry but does not satisfy the triangle inequality. This is natural because the illumination parameters are unknown and they are determined dynamically.

It should also be noted that the above described processes for computing the invariant distance includes a combination of both affine and illumination invariance. However, the processes described herein can also be used to determine invariant distances for just affine transformations, or for just illumination invariance, if desired for a particular application. For example, by using different parameters for the means and variances described in the preceding sections (i.e, parameters for μ and Σ, respectively), different invariant distances can be computed.

An example of the use of different parameters would be to use the means and variances of image patches of the input textures (e.g., break the input textures into small n×n squares, then compute means and the variances of these rn-dimensional samples, where m=3×n×n). Note that the factor of three used in determining the dimensionality of the samples in this example assumes the use of three-channel images, such as RGB color images, for example. In the case of four-channel images, such as CMYK images, for example, the dimensionality of the samples would be m=4×n×n. Clearly, this example of the use of different parameters for interpreting the means and variances to compute different invariant distances is not intended to limit the scope of what types of invariant distances may be computed by the GIRFT-based techniques described herein.

2.5 Considerations for Using GIRFT-Based Feature Descriptors:

The feature descriptors generated by the GIRFT-based techniques described above can be used to provide robust feature classification and analysis applications techniques by designing a suitable kernel based classifier. For example, although the GIRFT does not provide any explicit feature vector in the Rⁿ space, a kernel based classifier can still be designed. A simple example of such a kernel is provided by choosing a Gaussian kernel and computing a kernel matrix as illustrated by Equation (14):

$$K ( x , \tilde{x} ) = exp ( - \frac{{d}_{iv} ( x , \tilde{x} )}{2 {σ}^{2}} ) \qquad Equation ( 14 )$$

where σ can be any value desired (σ was set to a value of 55 in various tested embodiments). Given this type of kernel, conventional kernel based classification and analysis techniques, such as, for example, conventional kernel linear discriminant analysis (LDA) algorithms, can be used to provide robust feature classification and analysis.

As noted in Section 2.1, the GIRFT-based classification techniques described herein generally uses two adjustable parameters, Δα, and Δiv, neither of which requires careful adjustment, in order to generate feature descriptors from input textures. A third parameter, Δs, is generally simply fixed at 1 pixel for use in computing the Radon Transform of the input images (see Equation (1)). As discussed in Section 2.2, s is simply the signed distance (in pixels) from the origin to the line. Note that s can also be adjusted, if desired, with “Δs” being used in place of “s” to indicate that the value of s is adjustable. However, increasing Δs tends to increase computational overhead without significantly improving performance or accuracy of the feature descriptors generated by the GIRFT-based techniques described herein.

The Δα parameter is required by the discrete Radon Transform (see Equation (1)), which projects a pixel-based image in 180°/Δα directions. As such, larger values of Δα correspond to a smaller Radon-pixel image size due to the decreased number of projection directions. Further, it has been observed that classification accuracy of the feature descriptors generally decreases very slowly with the increase of Δα. In fact, increasing Δα from 10 to 60 was observed to result in a decrease in overall accuracy on the order of only about 5%. However, since the GIRFT-based techniques described herein require decreasing computational overhead with larger values of Δα (due to the smaller Radon-pixel image size), the Δα can be set by balancing accuracy and computational efficiency to provide the desired level of accuracy.

As discussed in Section 2.3, the bin size parameter, Δiv, is used for collecting the invariants in Equation (3). As noted in Section 2.3, the bin size, Δiv, was generally set within a range of 0<Δiv≦0.5. The bin size, Δiv, can be optimized through experimentation, if desired. In general, a larger bin size corresponds to a smaller feature vector. Thus, the bin size can also be set as a function of a desired size for the resulting feature vectors.

In view of the preceding discussion regarding parameters used by the GIRFT, i.e., Δα, Δiv, and Δs, it should be clear that little or no user interaction is required in order for the GIRFT-based classification techniques described herein to provide good results. In fact, the GIRFT process can operate effectively by simply setting the parameters, Δα, Δiv, and Δs, to default values in view of the considerations discussed above. Then, all that is required is for input textures to be manually or automatically selected for use in generating corresponding feature descriptors.

3.0 Operational Summary of the GIRFT:

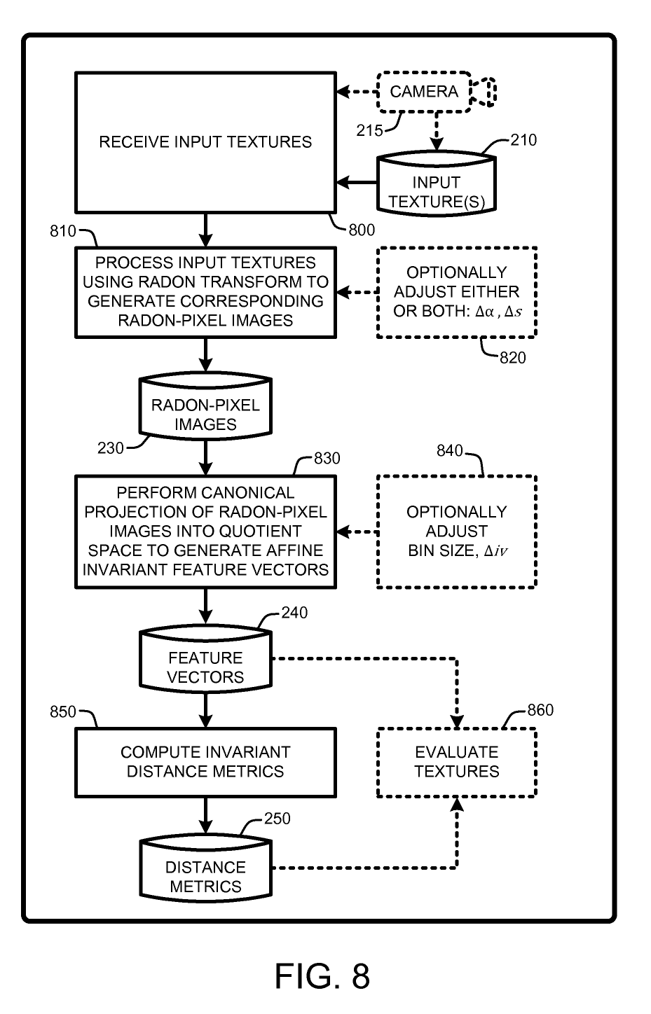

The processes described above with respect to FIG. 1 through FIG. 7 and in further view of the detailed description provided above in Sections 1 and 2 are illustrated by the general operational flow diagram of FIG. 8. In particular, FIG. 8 provides an exemplary operational flow diagram that summarizes the operation of some of the various embodiments of the GIRFT-based techniques described above. Note that FIG. 8 is not intended to be an exhaustive representation of all of the various embodiments of the GIRFT-based techniques described herein, and that the embodiments represented in FIG. 8 are provided only for purposes of explanation.

Further, it should be noted that any boxes and interconnections between boxes that are represented by broken or dashed lines in FIG. 8 represent optional or alternate embodiments of the GIRFT-based techniques described herein, and that any or all of these optional or alternate embodiments, as described below, may be used in combination with other alternate embodiments that are described throughout this document.

In general, as illustrated by FIG. 8, the GIRFT begins operation by receiving 800 a pair of input textures 210, from a database 210 of stored or pre-recorded textures, and/or from a texture input source, such as camera 215. These input textures 210 are then processed 810 using the Radon Transform to generate corresponding Radon-pixel images 230. As discussed above, in various embodiments, Radon Transform parameters, including Δα and Δs, are optionally adjusted 820 via a user interface or the like. However, also as noted above, these parameters can be set to default values, if desired.

Next, a canonical projection 830 of the Radon-pixel images 230 is performed to project Radon-pixel pairs into quotient space to generate affine invariant feature vectors 240 for each Radon-pixel image. Further, in various embodiments, bin size, Δiv, is optionally adjusted 840 via a user interface or the like. As discussed above, the bin size controls the number of projection directions used to generate the affine invariant feature vectors 240.

Next, invariant distance metrics 250 are computed 850 from the feature vectors 240 based on multivariate statistical distributions (e.g., Gaussians, mixtures of Gaussians, etc.) that are used to model each of the feature vectors. In various embodiments, further evaluation 860, classification, and analysis of the input textures 210 is then performed using the feature vectors 240 and/or distance metrics 250.

4.0 Exemplary Operating Environments:

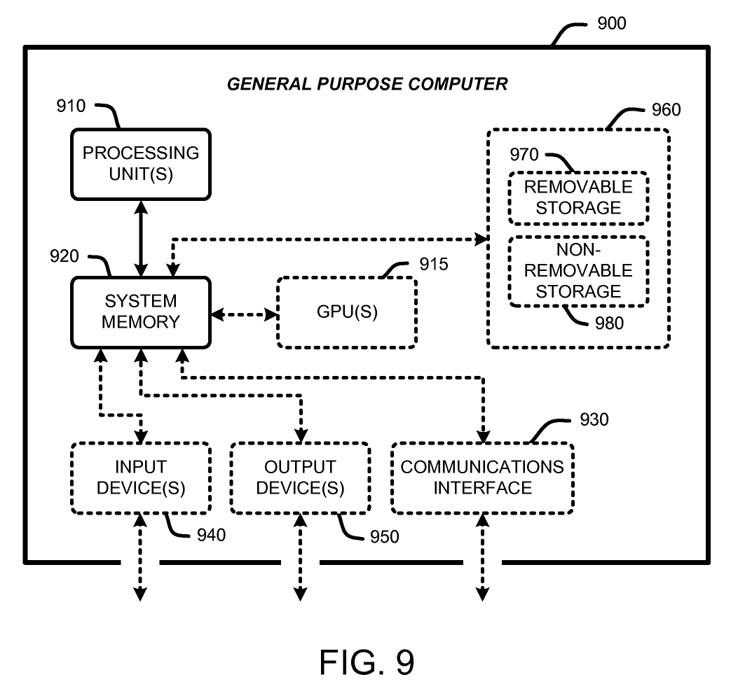

The GIRFT-based techniques described herein are operational within numerous types of general purpose or special purpose computing system environments or configurations. FIG. 9 illustrates a simplified example of a general-purpose computer system on which various embodiments and elements of the GIRFT, as described herein, may be implemented. It should be noted that any boxes that are represented by broken or dashed lines in FIG. 9 represent alternate embodiments of the simplified computing device, and that any or all of these alternate embodiments, as described below, may be used in combination with other alternate embodiments that are described throughout this document.

For example, FIG. 9 shows a general system diagram showing a simplified computing device. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, video media players, etc.

At a minimum, to allow a device to implement the GIRFT, the device must have some minimum computational capability along with some way to access and/or store texture data. In particular, as illustrated by FIG. 9, the computational capability is generally illustrated by one or more processing unit(s) 910, and may also include one or more GPUs 915. Note that that the processing unit(s) 910 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 9 may also include other components, such as, for example, a communications interface 930. The simplified computing device of FIG. 9 may also include one or more conventional computer input devices 940. The simplified computing device of FIG. 9 may also include other optional components, such as, for example one or more conventional computer output devices 950. Finally, the simplified computing device of FIG. 9 may also include storage 960 that is either removable 970 and/or non-removable 980. Note that typical communications interfaces 930, input devices 940, output devices 950, and storage devices 960 for general-purpose computers are well known to those skilled in the art, and will not be described in detail herein.

The foregoing description of the GIRFT has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the GIRFT. It is intended that the scope of the invention be limited not by this detailed description, but rather by the claims appended hereto.

What is claimed is:

1. A method for generating an affine invariant feature vector from an input texture, comprising, comprising steps for:
receiving a first input texture comprising a set of pixels forming an image;
applying a Radon Transform to the first input texture to generate a first Radon-pixel image;
identifying a first set of Radon-pixel pairs from the first Radon-pixel;
computing a dimensionality, m, of a feature space of the first Radon-pixel image using a pre-defined bin size;
applying an affine invariant transform to each pair of the Radon-pixels to transform the first Radon-pixel image into a first vector of an m-dimensional vector space; and
modeling the first vector using a multivariate distribution to generate a first affine invariant feature vector.

2. The method of claim 1 further comprising steps for generating a second affine invariant feature vector from a second input texture.

3. The method of claim 2 further comprising steps for computing an invariant distance metric from the first and second affine invariant feature vectors, and wherein the invariant distance metric provides a measure of similarity between the first input texture and the second input texture.

4. The method of claim 3 wherein the invariant distance metric is an affine invariant distance.

5. The method of claim 3 wherein the invariant distance metric is an illumination invariant distance.

6. The method of claim 3 wherein the invariant distance metric is a combined affine and illumination invariant distance.

7. The method of claim 1 wherein applying the affine invariant transform to each pair of the Radon-pixels further comprises steps for projecting each Radon-pixel pair into each dimension of the m-dimensional vector space.

8. A system for generating an invariant feature descriptor from an input texture, comprising:
a device for receiving a first input texture comprising a pixel-based image;
a user interface for setting parameters of a Radon Transform;
a device for generating a first Radon-pixel image from the first input texture by applying a Radon Transform to the first input texture;
a device for performing a canonical projection of the first Radon-pixel image into a multi-dimensional quotient space to generate a first affine invariant feature vector, said feature vector having a dimensionality determined as a function of a bin size specified via the user interface; and
a device for modeling the first affine invariant feature vector using a multivariate distribution to generate a first affine invariant feature descriptor.

9. The system of claim 8 further comprising a device for generating a second affine invariant feature descriptor from a second input texture.

10. The system of claim 9 further comprising a device for computing an invariant distance metric from the first and second affine invariant feature descriptors, and wherein the invariant distance metric provides a measure of similarity between the first input texture and the second input texture.

11. The system of claim 10 wherein the invariant distance metric is an affine invariant distance.

12. The system of claim 10 wherein the invariant distance metric is an illumination invariant distance.

13. The system of claim 9 further comprising:
a device for generating affine invariant feature descriptors for each of a plurality of input textures; and
a device for computing an invariant distance metrics from one or more pairs of feature descriptors to compare the input textures corresponding to pairs of feature descriptors.

14. A computer-readable medium having computer executable instructions stored therein for generating feature descriptors from pixel-based images, said instructions comprising:
receiving one or more input images;
for each input image:
generating a Radon-pixel image by applying Radon Transform to the image, wherein each Radon-pixel of the Radon-pixel image corresponds to line segment in the input image;
projecting the Radon-pixel image into a vector in an m-dimensional vector space to generate an affine invariant feature vector, wherein the dimensionality of the m-dimensional vector space is determined as a function of a pre-defined bin-size;
modeling the feature vector using a multivariate distribution to generate an affine invariant feature descriptor.

15. The computer-readable medium of claim 14 further comprising instructions for comparing one or more pairs of the input images by computing an invariant distance metric for each pair of input images, and wherein the invariant distance metric provides a measure of similarity between each pair of input images.

16. The computer-readable medium of claim 15 wherein the invariant distance metric is an illumination invariant distance that is insensitive to illumination differences in the images comprising each pair of input images.

17. The computer-readable medium of claim 15 wherein the invariant distance metric is an affine invariant distance that is insensitive to affine transformations of either image comprising each pair of input images.

18. The computer-readable medium of claim 15 wherein the invariant distance metric is a combined affine and illumination invariant distance that is insensitive to both illumination differences and affine transformations of the images comprising each pair of input images.

19. The computer-readable medium of claim 14 further comprising a user interface for selecting one or more of the input images use in generating the affine invariant feature descriptors.

20. The computer-readable medium of claim 14 further comprising a user interface for adjusting parameters of the Radon Transform.
